(19) United States
(12) Patent Application Publication
(10) Pub. No.: US 2004/0124297 A1
(43) Pub. Date: Jul. 1, 2004

(54) Fishing indicator device

(76) Inventor: Steven Lance Steer, Victoria (AU)

Correspondence Address: MICHAEL BEST & FRIEDRICH, LLP, 100 E WISCONSIN AVENUE, MILWAUKEE, WI, 53202, US

(21) Appl. No.: 10/737,224

(22) Filed: Dec. 16, 2003

Related U.S. Application Data
(63) Continuation of application No. 09/214,729, filed on Jan. 11, 1999, now abandoned.
Application No. 09/214,729 is a 371 of international application No. PCT/AU97/00409, filed on Jun. 27, 1997.

(30) Foreign Application Priority Data
Jul. 12, 1996 (AU) P00958
Dec. 6, 1996 (AU) P04040

(51) Int. Cl. A01K 89/00

(52) U.S. Cl. 242/223

(57) ABSTRACT

A fishing indicator device is disclosed which includes a magnet (32, 507) and a reed switch (30, 430) for detecting the magnet and providing an output signal. A display (40, 412) is provided which includes a processor for receiving the output signal and for calculating a particular parameter indicative of movement of fishing line retrieval speed, distance of line movement and bite indication for display on the display (40, 412) or for causing an alarm to sound. The reed switch (30, 430) may be coupled to the processor and display (40) by hard wiring or by wireless transmission. The magnet (32, 507) may be provided on a rotatable wheel (402) which receives the line so that when the line moves, the wheel is rotated to cause the magnet to pass the reed switch (30, 430) so that the reed switch outputs the signal. The wheel (402, 442) may be housed within a housing (400) and the wheel and housing (400) may form one of the line guides which is coupled to the fishing rod for guiding the line. The display (40, 412) may include a mode button (46, 417) for causing the processor to switch between various modes for displaying various different parameters.

This invention relates to a fishing indicator device and to a fishing reel and/or rod including the device.

In the art of fishing, it is well understood that finding the fish in their surrounding environment is half of the battle and that the presentation of the bait or lure in the correct manner is also of great importance. Fish of various types are found to inhabit various underwater environments. For example, certain fish varieties are found in particular water depths or water temperatures. Some fish varieties are found to inhabit rocky or reef areas, others are found to inhabit sandy or weedy areas and so on. Fish of all types tend to congregate around areas that suit their needs, sometimes in large numbers. Therefore, if a fisherman has caught a fish or had strikes in a particular area, it would make sense to place his bait or lure in the exact area again, and in the correct manner so as to enhance his chances of further success.

It is well known in fishing circles that a group of fishermen can fish almost side by side with one fisherman out of the group, catching many fish, while the fishermen on either side of him may not catch any even though they were using the same bait or lure as the successful fisherman. Many people put this down to pure luck, but luck only plays a minor role, what you may find is that the fisherman that caught all or most of the fish had placed and presented his bait or lure in the correct area, in the correct manner that suited the liking of the fish species caught.

These certain areas as described above where fish like to congregate due to the underwater environment of that particular area, are rarely discernible to the fishermen due to water coverage, wave action, darkness or other factors. Such productive areas could be a deep washed out hole in the sand, it may be a gutter edge, a drop off into deeper water, an underwater structure as in a rock or clump of reef, or it may be as subtle as the edge of a current flow. Whatever is the case, these productive areas may be as little as a metre or two across, so it is important that once one of these productive areas is found, that the fisherman's bait or lure can be placed in that precise area and in the same manner to increase the chance of further success.

Furtherstill, in lure fishing, because lures of different shapes, styles, sizes or weights have different actions, designed to entice certain varieties of fish and these lures vary in action at different speeds, lure manufacturers often designate a certain species or range of species for which that specified lure is designed to entice. When pulled through the water, the lure is designed to mimic an injured or natural action of a natural food source of the targeted species. Therefore lure speed being crucial to achieve desired action. With the range of lures on the market today, it is almost impossible for any fisherman, particularly a novice fisherman to become familiarised with the optimum speed of retrieval for all varied types.

At the time of this invention, to the knowledge of the inventor, there are no devices which offer a fisherman any assistance in these endeavours. Thus, it is very difficult if not impossible for a fisherman to succeed in placing their bait or lure at a desired spot repeatedly or retrieve their lure or bait repeatedly at the optimum speed to enhance their success.

The invention, in a first aspect, may be said to reside in a fishing indicator device for a fishing reel and/or fishing rod including:

a sensor for sensing retrieval of a fishing line onto a reel for producing a signal indicative of the retrieval of the fishing line;

processing means for receiving said signal and for producing an output signal indicative of retrieval speed of the line; and

indicating means for indicating said speed.

The first aspect of the invention may also be said to reside in a fishing reel and/or fishing rod, including:

a sensor for sensing retrieval of a fishing line onto a reel for producing a signal indicative of the retrieval of the fishing line;

processing means for receiving said signal and for producing an output signal indicative of retrieval speed of the line; and

indicating means for indicating said speed.

Thus, in order to retrieve the line at a particular speed, the fishing reel need only be rewound until the retrieval speed matches that which produced the previous success or which is that recommended by the manufacture of the lure to ensure that the lure is retrieved at the desired rate to produce the required characteristics to entice a fish. Thus, by use of the fishing display device or the fishing reel or rod according to this aspect of the invention, an indication of retrieval speed of a lure can be obtained so that the fisherman has an indication as to whether the desired result has been achieved and if not corrections can be made to produce the desired result.

Preferably the indicator means comprises a visual display which displays the parameter. However, in other embodiments the indicator means could be an audible indication which sounds if the speed of movement of the line is outside a desired range so that if no sound is heard, the fisherman has an indication that the speed of retrieval is appropriate and if the sound is heard the fisherman knows the speed is not correct and can change the speed of retrieval to achieve the desired result.

In one embodiment of the invention, the sensor comprises a magnet attached to a spool of the fishing reel or a rotating bail arm of a fishing reel or any moving part of the reel, and a magnetic switch means fixed to a casing portion of the fishing reel so that each time the magnet passes the magnetic switch means, an output pulse is produced indicative of the movement of the spool or the bail arm or moving part to thereby provide an output indicative of movement of the fishing line wound onto or off or cast off the spool, or onto the spool via the bail arm or any moving part.

Preferably the display means comprises a liquid crystal display producing a numeric indication of the parameter.

The invention also provides a fishing indicator device for a fishing reel and/or fishing rod, including:

a sensor for sensing movement of a fishing line and for producing a signal indicative of the movement of the fishing line;

processing means for receiving said signal and for calculating a plurality of parameters relating to movement of the fishing line;

indicating means for indicating said parameters; and

control means for controlling said processing means to output an output signal indicative of an appropriate one of said parameters for display so that the control means can be activated to us each of the parameters to be displayed dependent upon which parameter is required by a user.

In particular embodiments of this aspect of the invention, the parameter may be a speed of movement of the fishing line indicating a rate of retrieve of the fishing line in, for example, kilometres per hour, miles per hour, meters per second or yards per second, a distance of travel of the line indicating a distance of a cast in meters or yards or feet, or a distance the line has been dropped in water giving a depth of water in meters, yards, feet or fathoms.

Preferably, the control means is in the form of a mode button associated with the processing means which, upon actuation, can select a particular mode such as the rate of retrieve, distance of cast or depth of water.

In one embodiment of the invention, the display means is associated with the fishing reel.

However, in other embodiments, the display means may be associated with the fishing rod itself.

In one embodiment of the invention, the display means is coupled to the processing means and the sensor by hard wiring.

In other embodiments, a wireless communication device may be used to transmit the signal from the sensor to the processing means and/or from the processing means to the display means.

A further aspect of the invention relates to a fishing indicator device which provides further advantages to those previously described.

Thus, a further aspect of the invention may be said to reside in a fishing indicator device, including:

a movable member for engagement with a fishing line so that when the fishing line moves relative to a fishing rod or fishing reel, the movable member is moved by the moving fishing line;

movement response means for providing an output in response to the movable member; and

indicating means for indicating a parameter related to movement of the fishing line in response to the output of the movement response means.

This aspect of the invention may also be said to reside in a fishing rod including:

a guide element for guiding a fishing line;

a movable member coupled to the guide for engagement by the fishing line so that when the fishing line moves relative to the guide, the movable member is moved by the fishing line.

In this aspect of the invention, the fishing line drives the movable member as the fishing line moves during casting or retrieval which in turn causes the movement response means to provide the output to enable the parameter to be displayed on the indicating means. This aspect of the invention does not require the sensor to sense rotation of the reel or a bail arm to in turn provide an indication of the amount of line which is wound off the reel or back onto the reel as in the earlier aspects of the invention. Thus, since the moving means is moved by the fishing line, the moving means will move in proportion to the movement of the fishing line, such as in direct proportion, so a more accurate measure of the amount of movement of the fishing line can be obtained. In the earlier mentioned aspects of the invention, since the amount of line wound off the reel or onto the reel with each rotation of the reel or bail arm changes as the diameter of the spool of line on the reel changes, errors in the measurement of the amount of line wound onto the reel and off the reel do occur in view of that change in spool diameter. This aspect of the invention does not rely on merely monitoring movement of the reel or bail arm but instead monitors movement of a movable member which can be directly proportioned to the amount of line wound on or off the fishing reel so that a more accurate measure of the amount of line wound onto or off the reel can be obtained to, in turn, provide a more accurate measure of the parameter required by the fisherman.

Preferably the movable member is a rotatable wheel which is rotated by movement of the fishing line, the wheel carrying a magnet.

Preferably the rotatable wheel has a circumferential groove for accommodating the fishing line to guide the fishing line about the circumference of the wheel so that when the fishing line moves, the fishing line rotates the wheel.

Preferably the movement response means comprises:

a sensor fixed in a stationary position so that the rotatable wheel can rotate relative to the sensor, the sensor producing a sensor signal in response to rotary movement of the wheel and the magnet each time the magnet passes the sensor; and

processing means for receiving said sensor signal and calculating said parameter and for outputting said output indicative of said parameter to said indicating means.

Preferably the indicating means is a visual display for receiving said output and displaying said parameter.

In the preferred embodiments of the invention, the output is an electrical signal.

In other embodiments, the movement response means comprises a rotary member for engaging the disc and the indicating means is a mechanical display, the output being mechanical drive transmitted from the rotary member to the mechanical display to cause the mechanical display to display the parameter.

The rotary member may comprise part of the mechanical display or may be a separate member interposed between the movement response means and the mechanical display.

In other embodiments the rotary member may comprise a chopper or shutter for interrupting a light beam and the movement response means may include a light sensor for providing an output each time the light beam is interrupted by the chopper or shutter. In other embodiments, a capacitive sensor could be used.

As in the earlier aspects of the invention, the parameter to be displayed may be speed of movement of the fishing line indicating a rate of retrieval of the fishing line or a distance travelled by the line indicating the distance of a cast or the depth to which the line has been dropped in water.

As also described with reference to the earlier aspects of the invention, the processor may include a mode button so that a particular mode can be selected to display a different parameter or a number of parameters at the one time. The device of this aspect of the invention may also have attachment means for attaching the device to a fishing rod or to a fishing reel. Thus, the device may be connected on a fishing rod or the fishing reel. Furthermore, the device may include wireless transmission between the sensor and the processor and/or between the processor and the display.

Also, according to this aspect of the invention, the device may be formed as a fixture on the rod or a section of the rod with the processor being arranged within the rod or embedded within the rod or as a fixture on the reel.

The invention still further provides a fishing rod and reel combination including:

a fishing rod having a display for displaying a parameter concerning movement of a fishing line;

contacts on the fishing rod;

a fishing reel including a sensor for sensing movement of a fishing line and for producing a signal indicative of the movement of the fishing line; and

contacts on the fishing reel for engaging the contacts on the fishing rod when the fishing reel is coupled to the fishing rod so that the sensor is coupled to the display.

This aspect of the invention may also be said to reside in a fishing rod for use with a fishing reel, including a sensor for sensing movement of a fishing line and for producing a signal indicative of movement of the fishing line, the fishing reel having a first set of contacts for receiving the signal, including:

a display coupled to the rod for displaying a parameter related to movement of the fishing line;

second contacts on the fishing rod for making electrical contact with the first contacts on the fishing reel so that the signal indicative of movement of the fishing line can be supplied from the fishing reel to the display via the first and second pair of contacts, when the fishing reel is engaged with the fishing rod.

This aspect of the invention may also be said to reside in a fishing reel for use with a fishing rod having display for displaying a parameter related to movement of the fishing line, including:

a sensor for sensing movement of the fishing line and for producing a signal indicative of the movement of the fishing line;

a second pair of contacts on the fishing reel for engaging the contacts on the fishing rod when the fishing reel is coupled to the fishing rod so that the signal can be supplied from the sensor on the fishing reel to the display on the fishing rod.

Preferably the invention includes processing means which may be including in the display on the fishing rod or in the reel.

The invention also provides a fishing indicator device for a fishing reel and/or fishing rod, including:

a sensor for sensing movement of a fishing line and for producing a signal indicative of the movement of the fishing line;

wireless transmitter means coupled to the sensor for outputting an output signal;

receiver means for receiving the output signal from the transmitter means; and

display means coupled to the receiver means for displaying a parameter related to the movement of the fishing line.

Preferred embodiments of the invention will be described, by way of example, with reference to the accompanying drawings, in which:

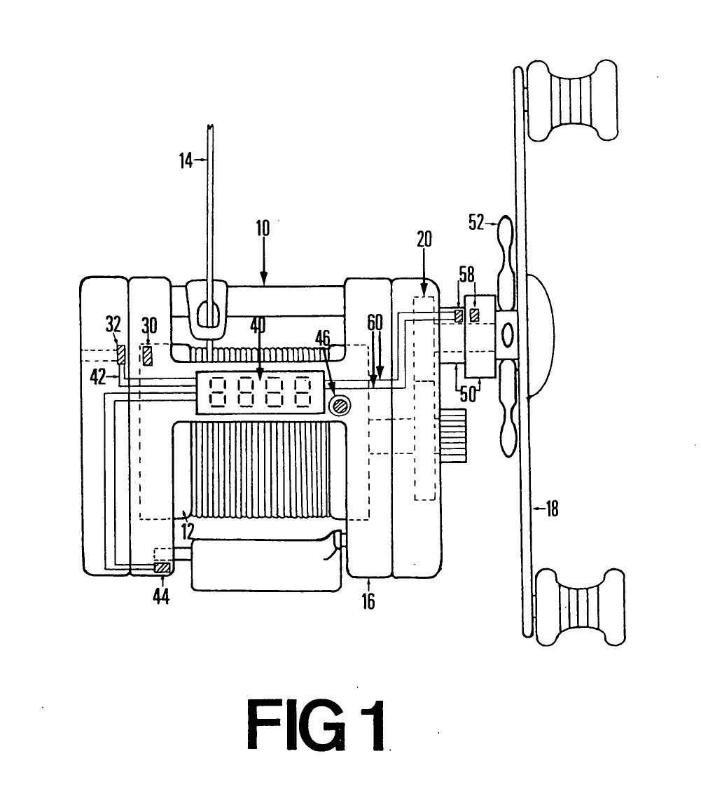

FIG. 1 is a view of a fishing reel according to a first embodiment of the invention;

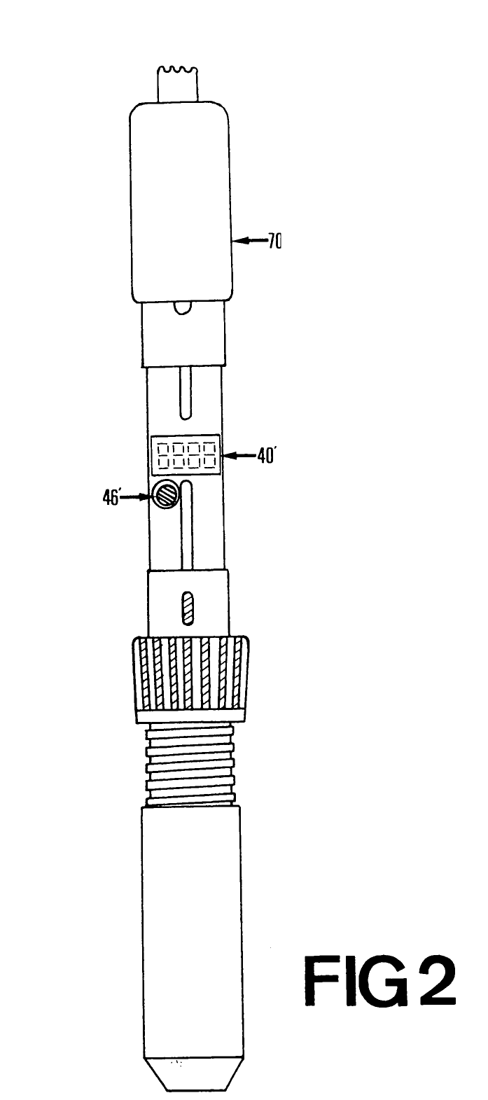

FIG. 2 is a view of a fishing rod according to yet a further embodiment;

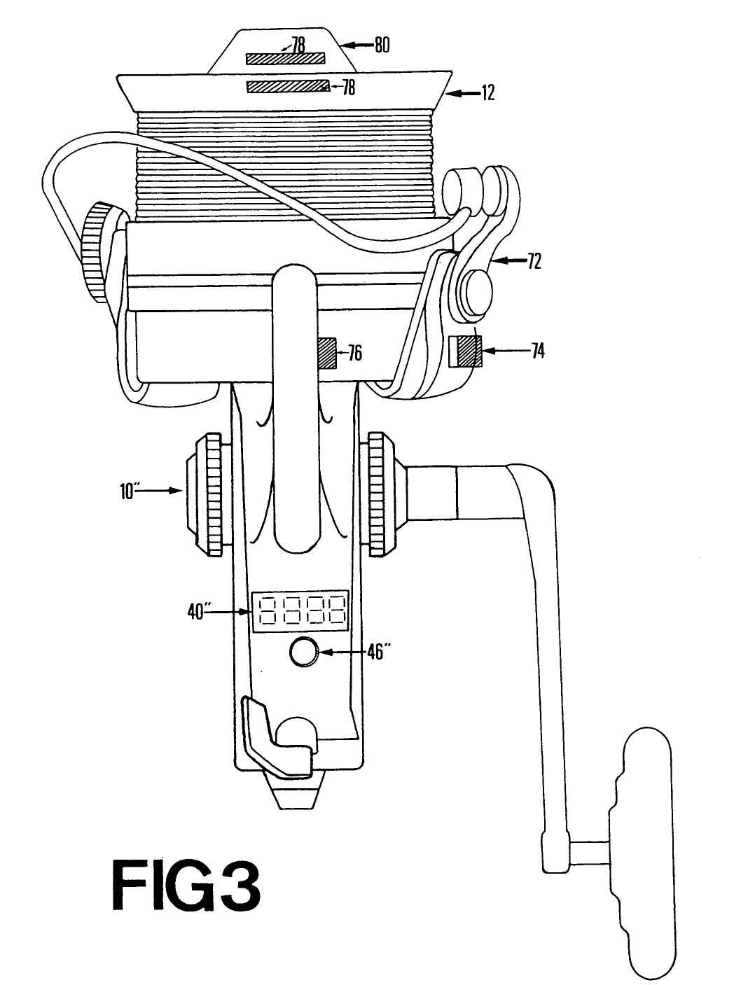

FIG. 3 is a view of a fishing reel according to another embodiment of the invention;

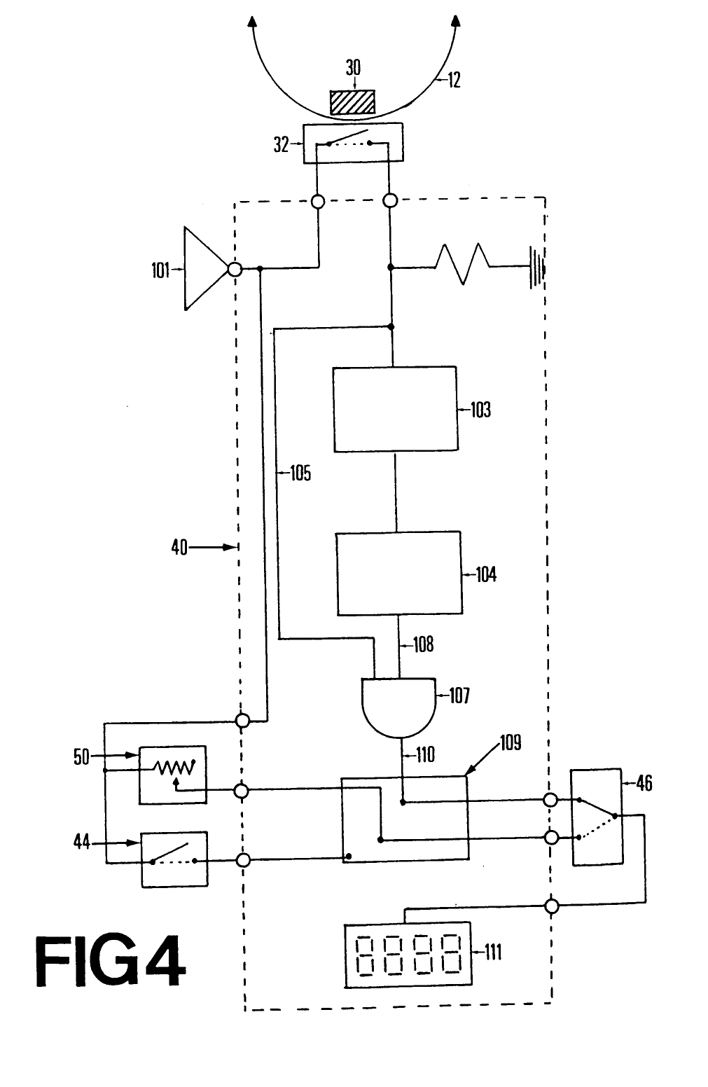

FIGS. 4 and 5 are schematic block diagrams relating to the preferred embodiments of the invention;

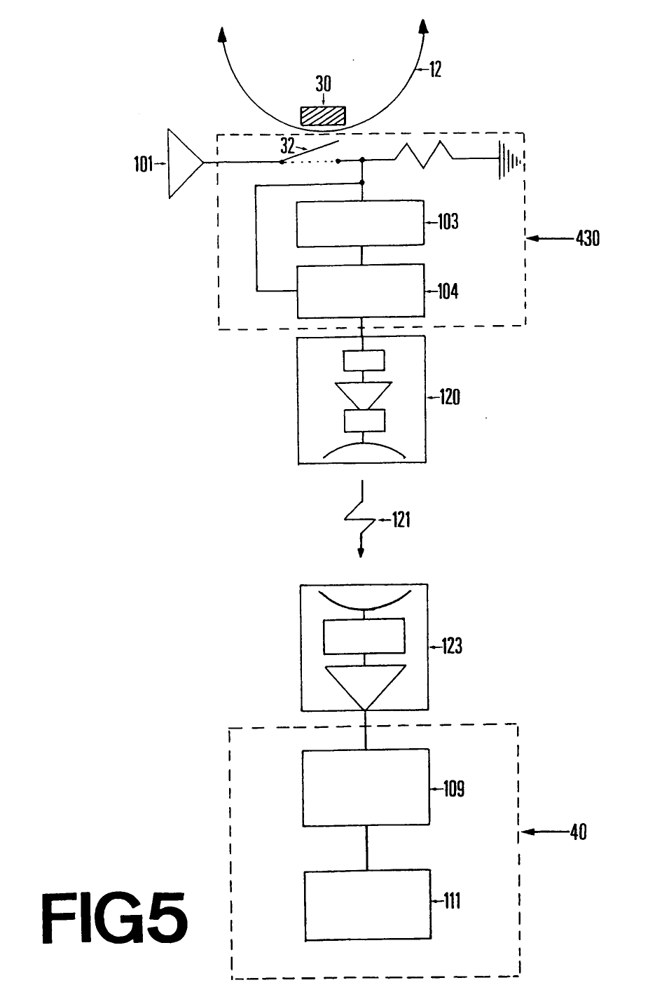

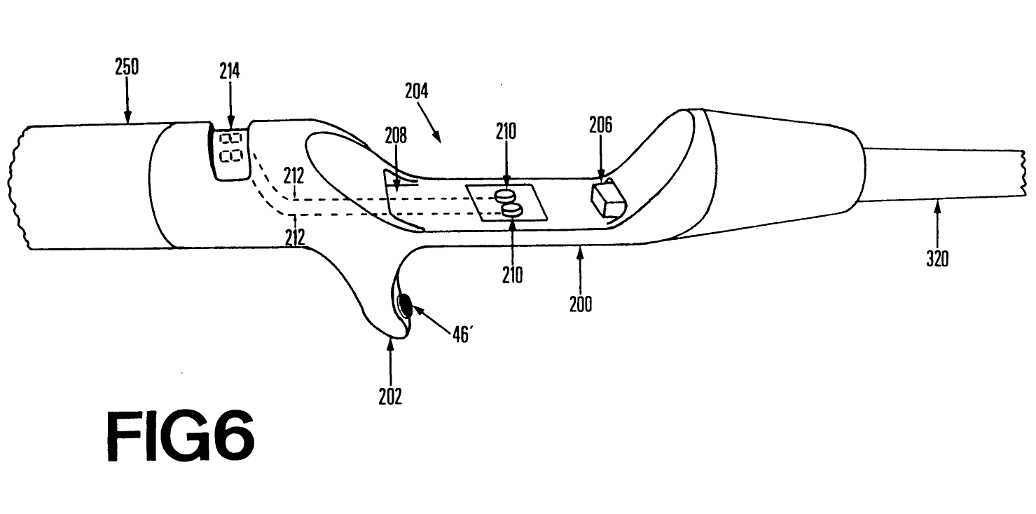

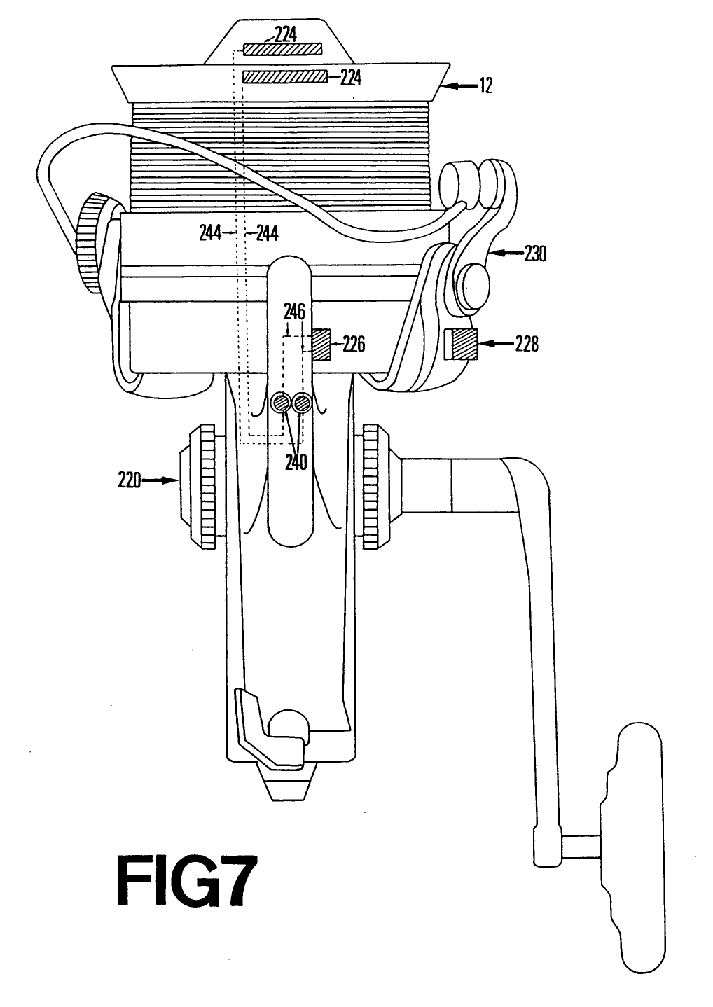

FIGS. 6 and 7 are drawings of a rod and reel respectively according to a further embodiment of the invention;

FIG. 8 is a plan view of a device according to a further embodiment of the invention;

FIG. 9 is a side view of the device of FIG. 8 mounted on a fishing rod;

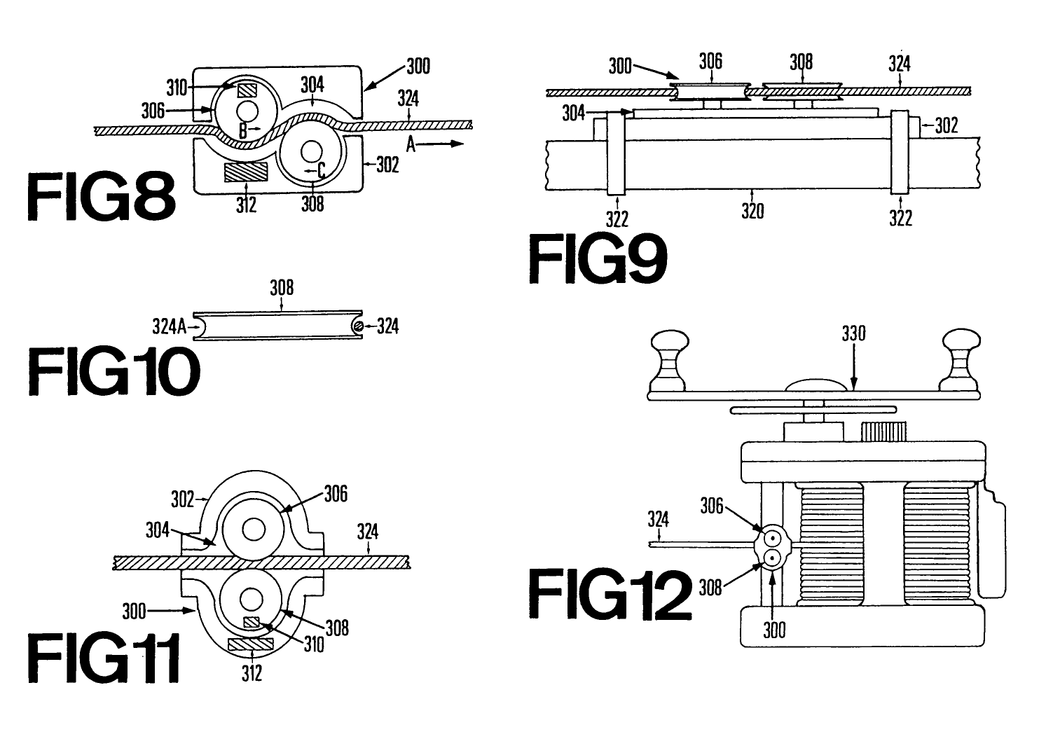

FIG. 10 is a view of part of the device of FIG. 9;

FIG. 11 is a view of a further embodiment;

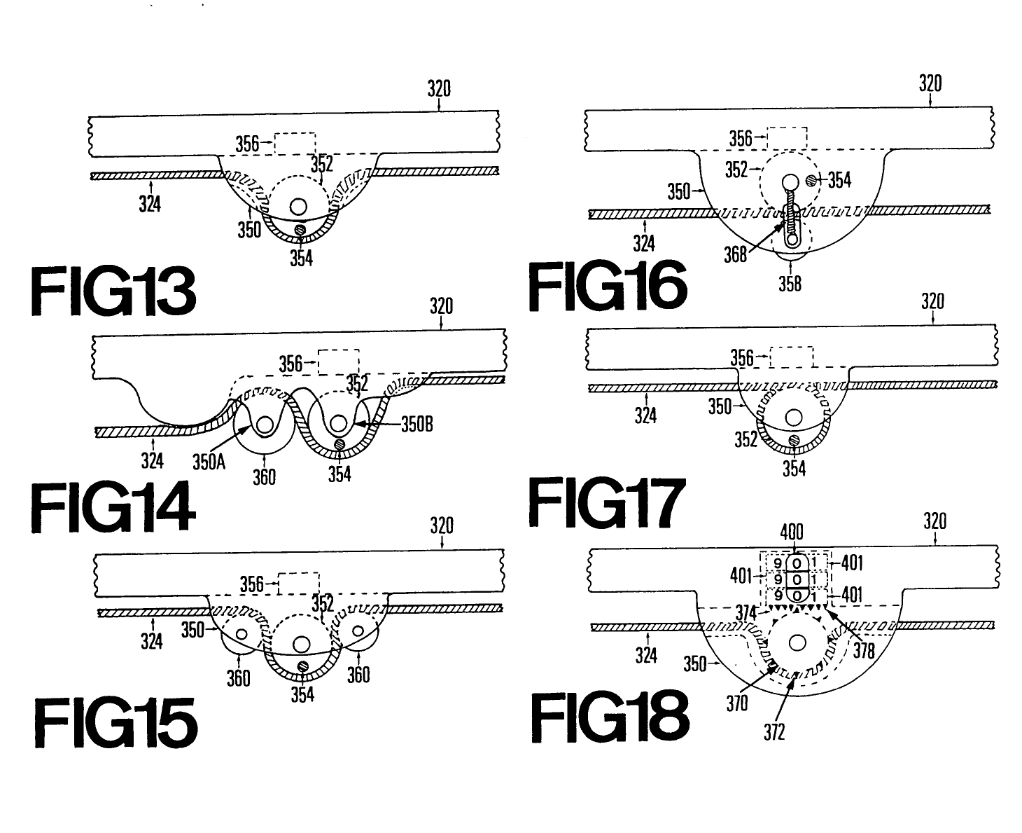

FIG. 12 is a plan view of the embodiment of FIG. 11 mounted on a reel;

FIGS. 13 to 18 show still further embodiments of the invention formed on a fishing rod or section of a fishing rod;

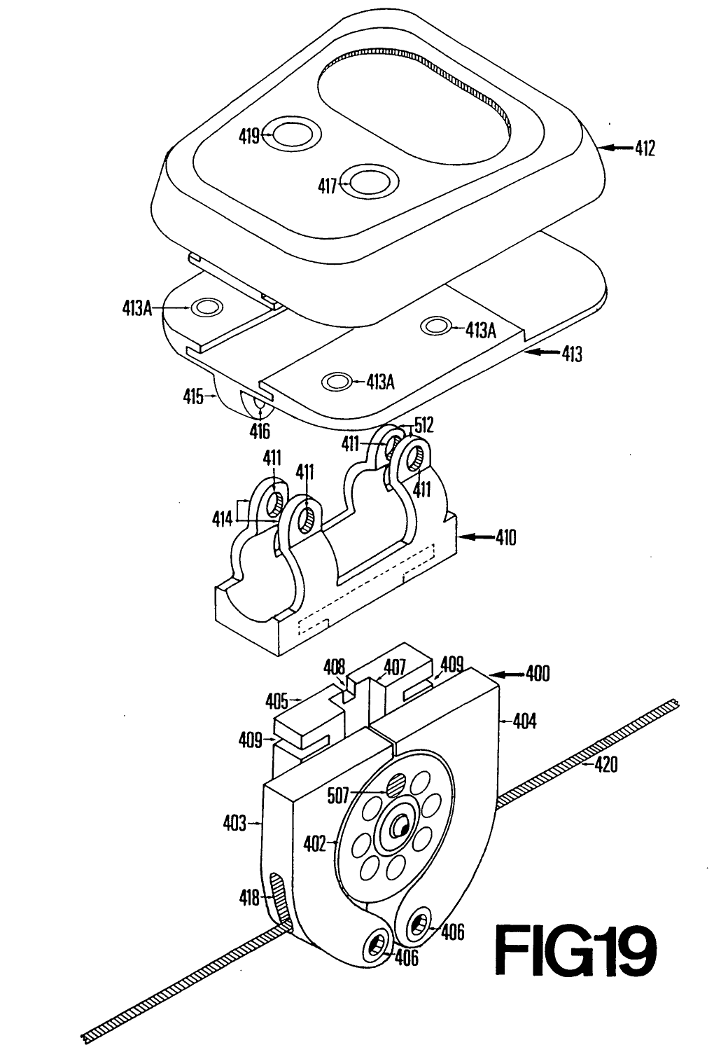

FIG. 19 is a view of yet a further embodiment of the present invention;

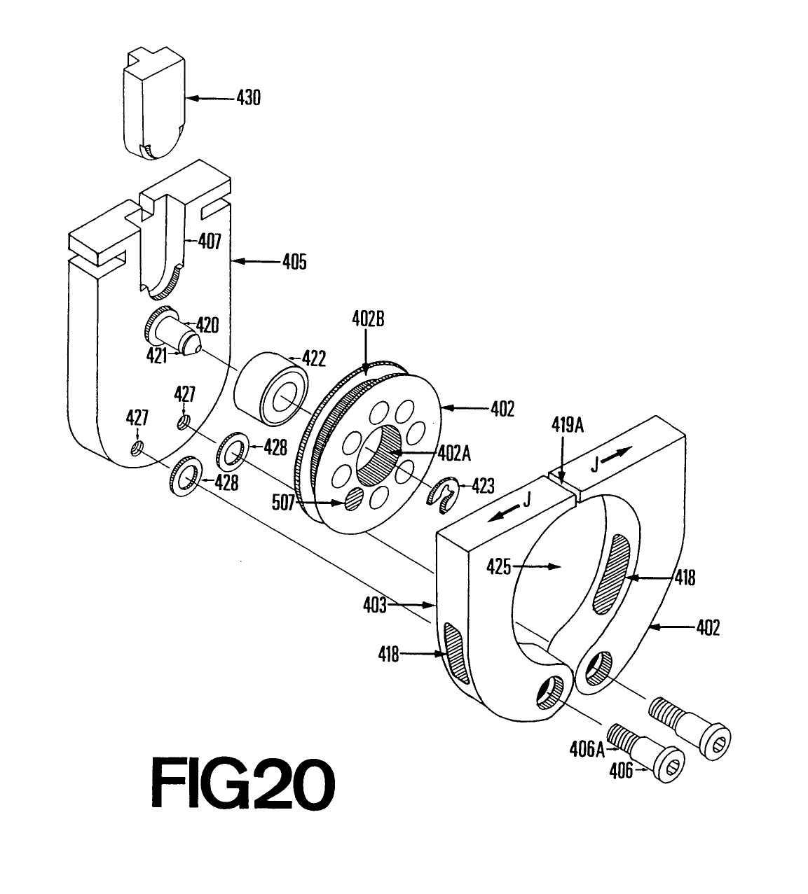

FIG. 20 is an exploded view of part of the embodiment of FIG. 19;

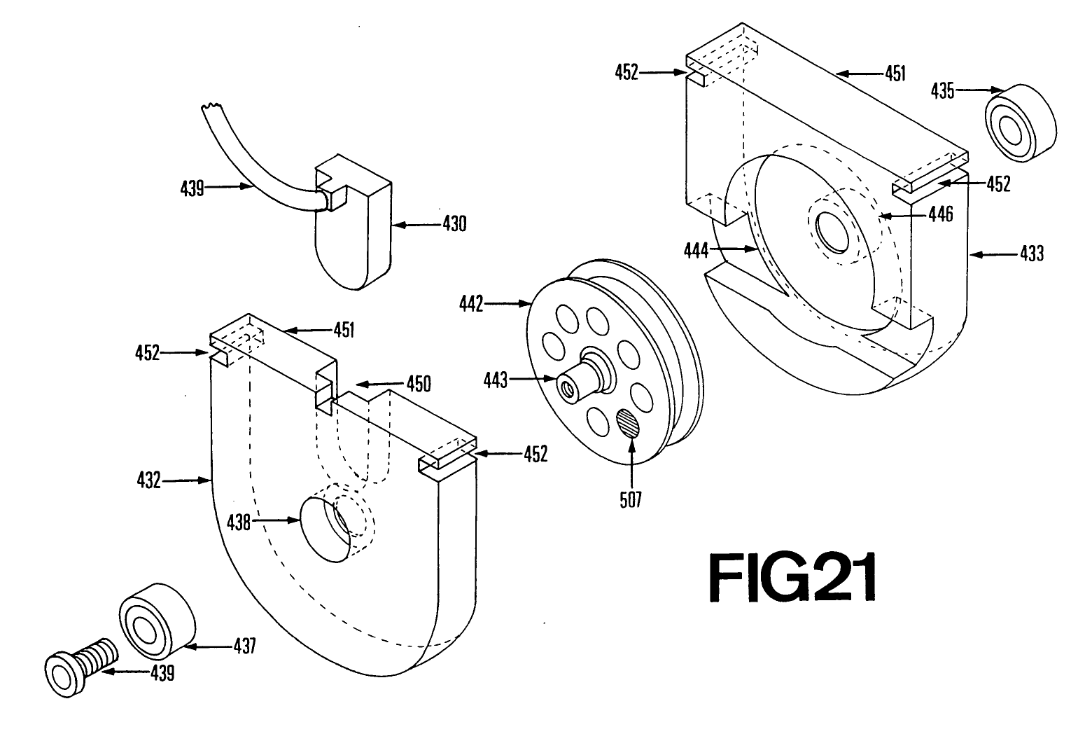

FIG. 21 is a view of yet a further embodiment of the invention;

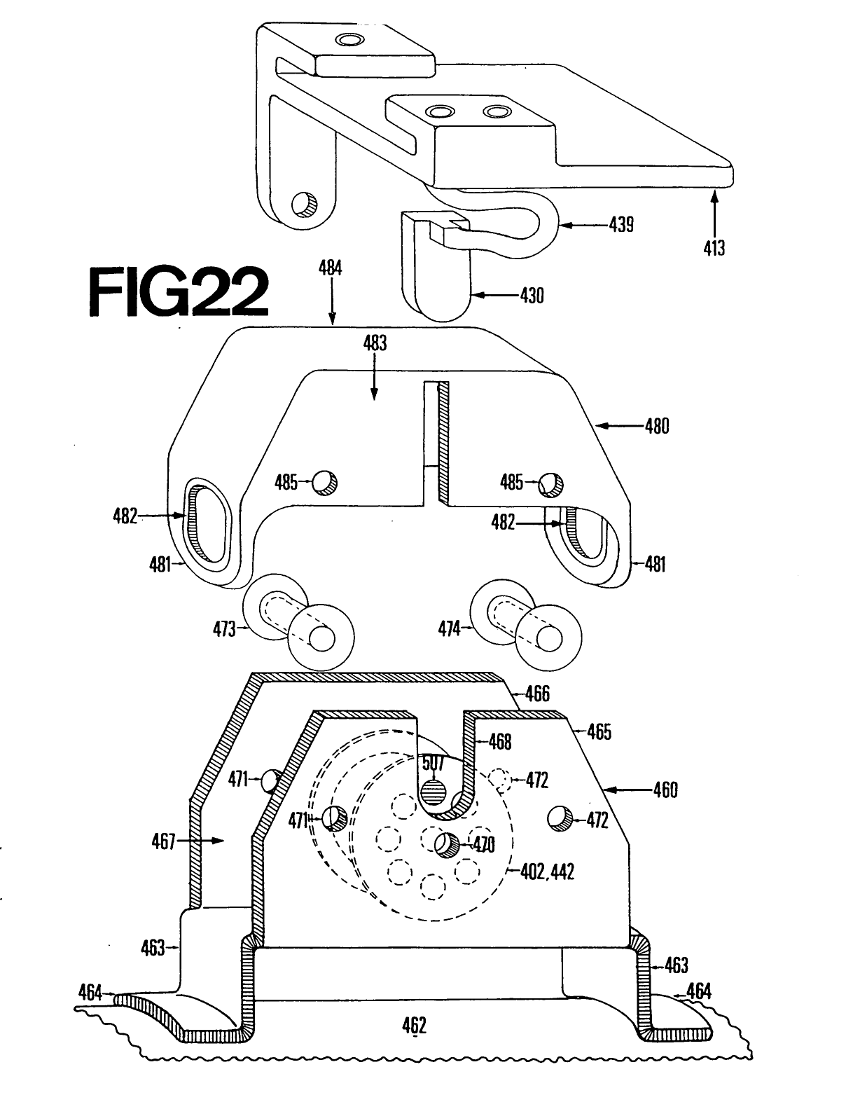

FIG. 22 is a view of a still further embodiment of the invention;

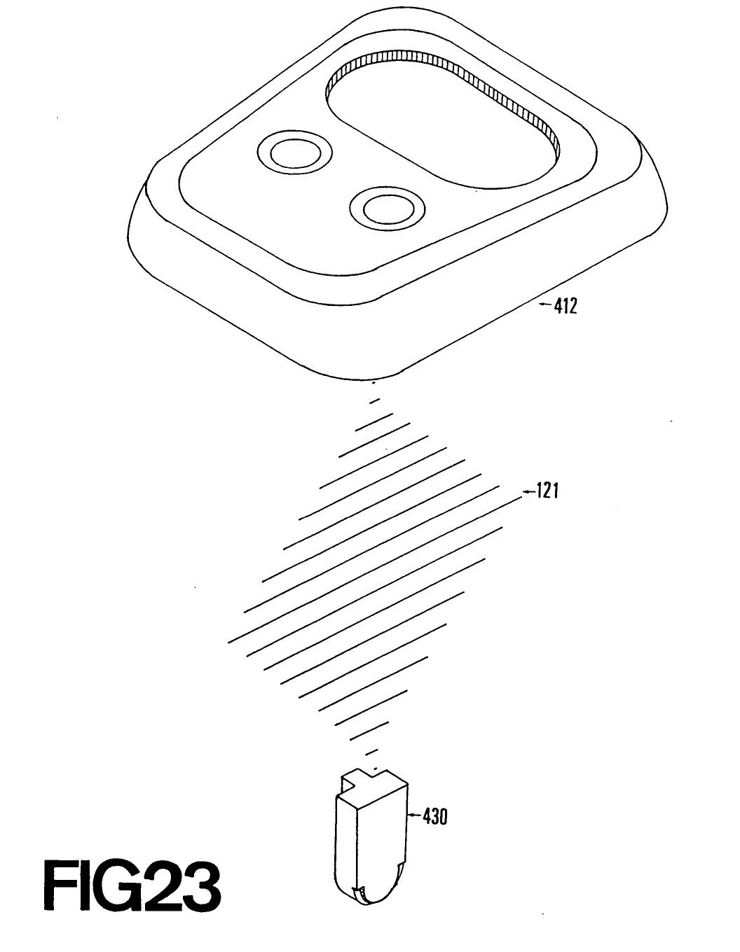

FIG. 23 is a view of yet another embodiment of the invention;

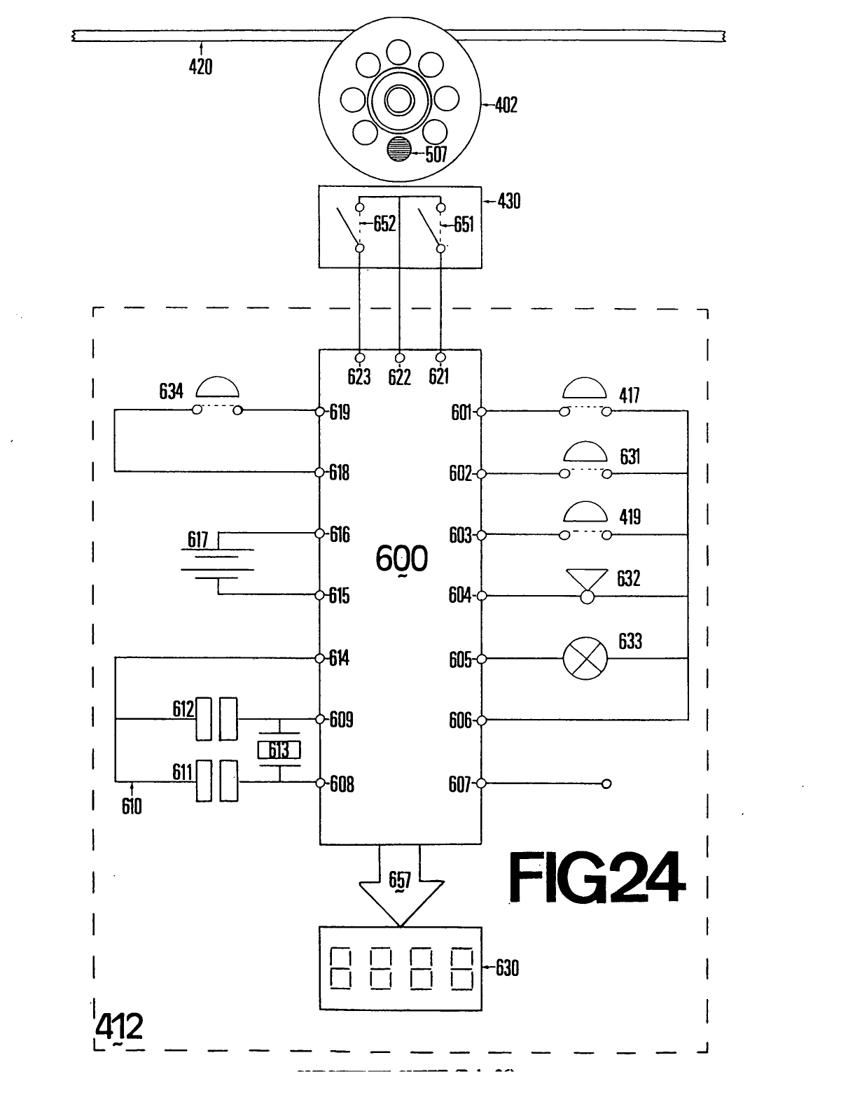

FIG. 24 is a diagram of the processing circuitry according to one embodiment of the invention;

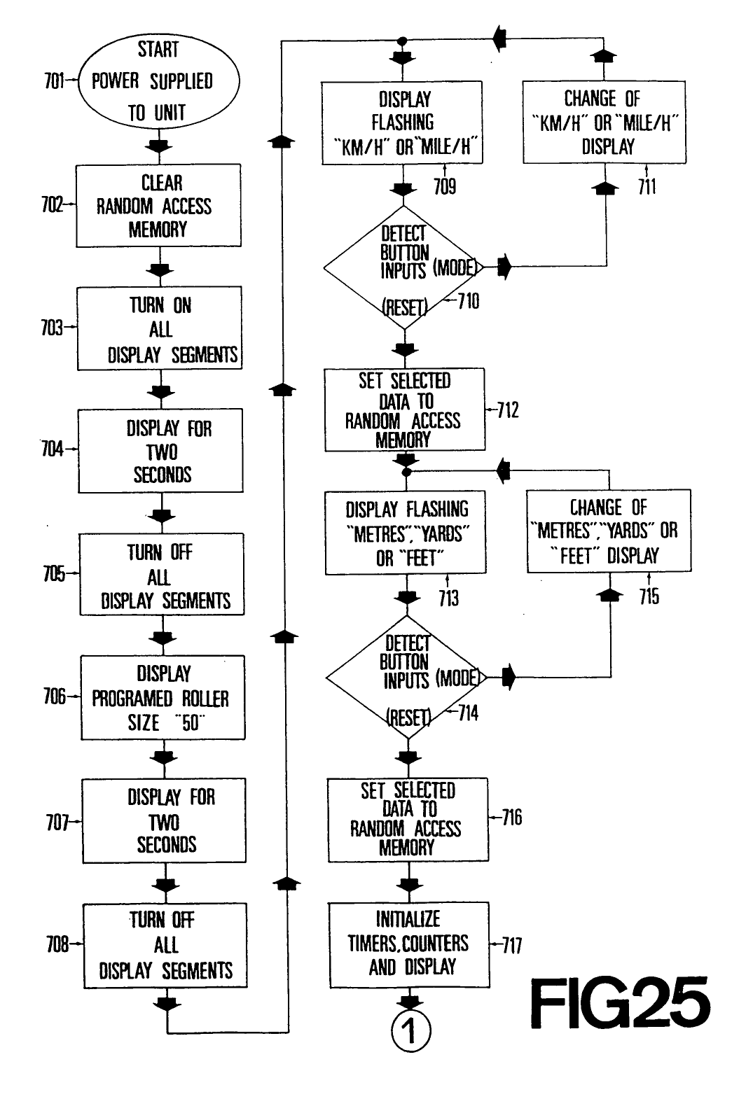

FIG. 25 is a flow sheet illustrating operation of the processor of FIG. 24;

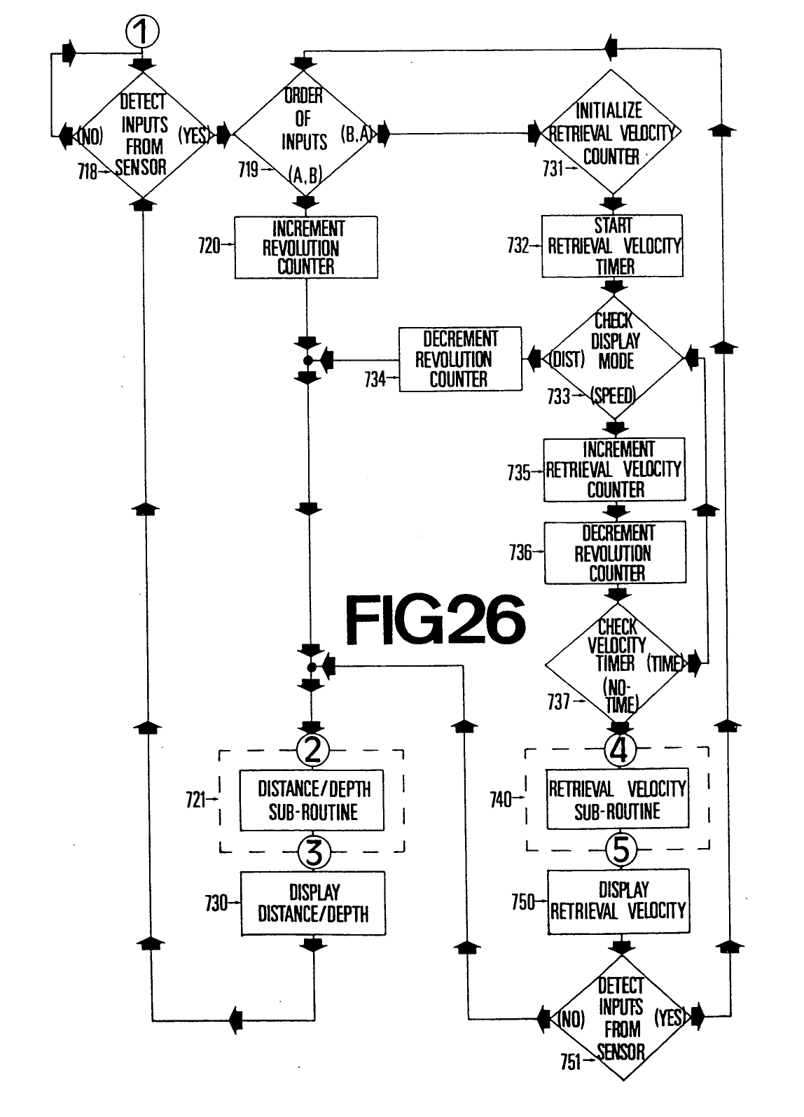

FIG. 26 is a continuation of the flow sheet of FIG. 25;

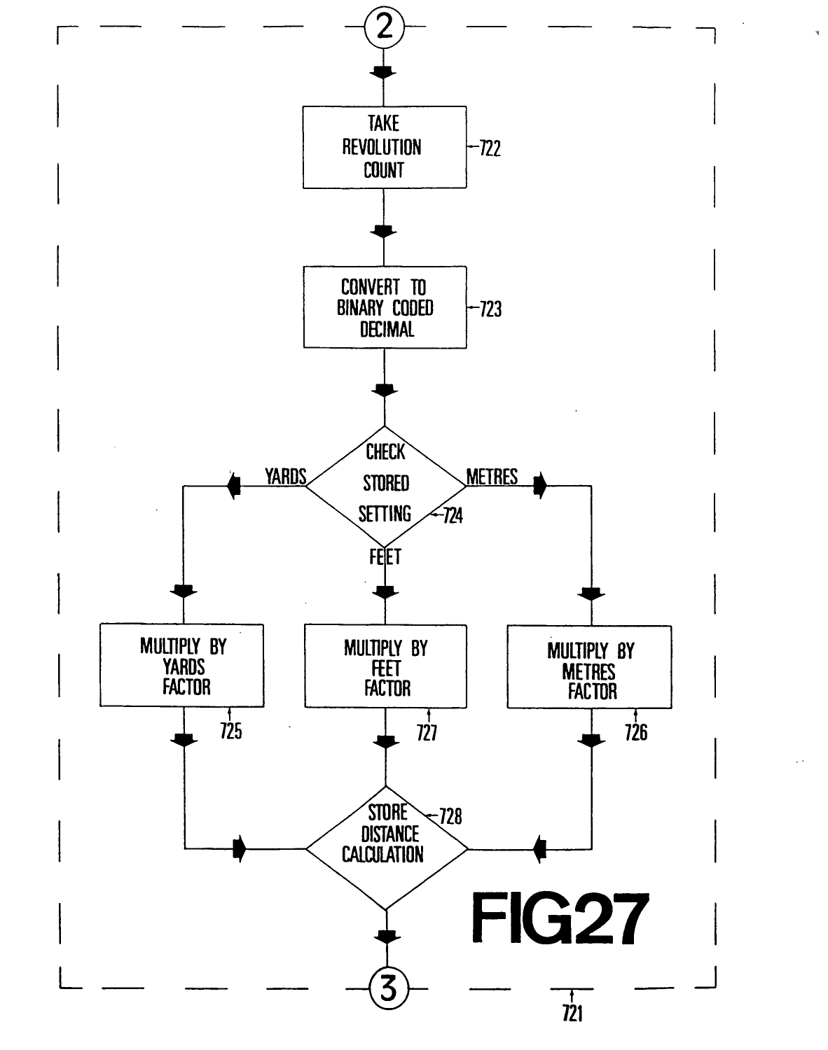

FIG. 27 shows one of the subroutines of the flow sheet of FIG. 26; and

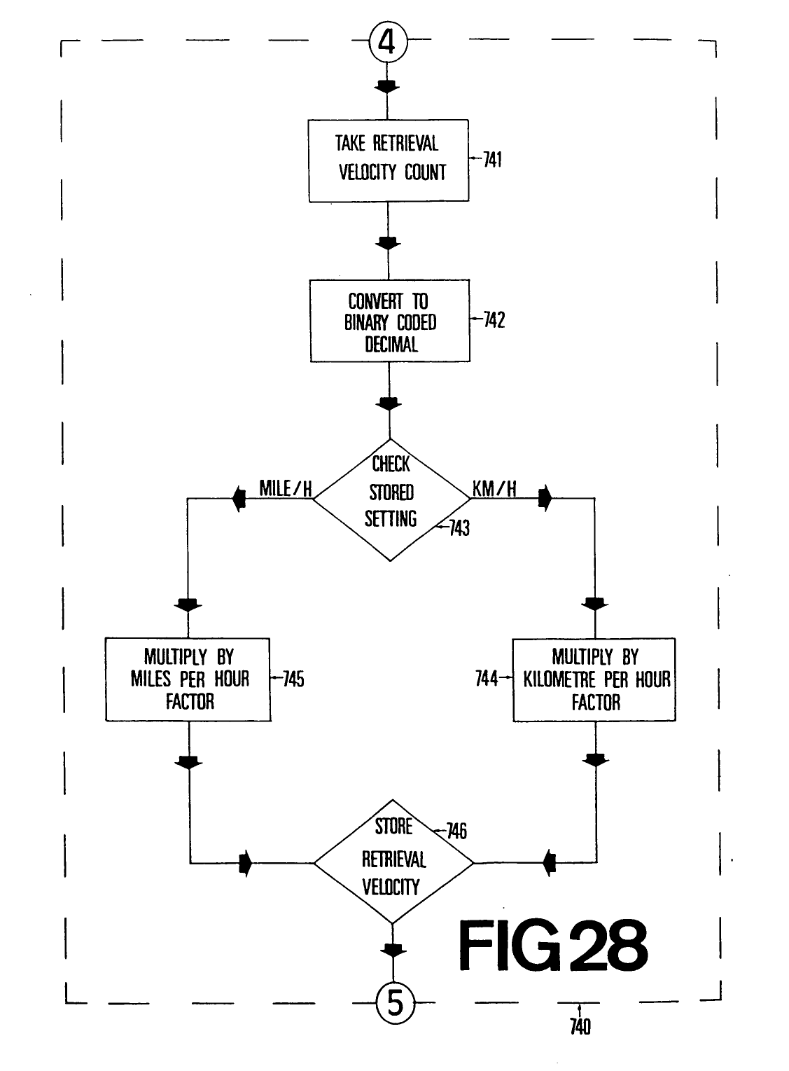

FIG. 28 shows another subroutine of the flow sheet of FIG. 26.

With reference to FIG. 1, a fishing reel 10 is shown which is adapted to be attached to a fishing rod in a manner known in the art. The fishing reel 10 is generally of known design and therefore will not be described in full detail other than to say that it includes a spool 12 onto which a line 14 is wound. The spool 12 is rotatably held within a casing 16 and can be wound by handle 18 which is coupled to the spool 12 via a transmission 20.

The spool 12 has a magnet 30 fixed to it for rotation with the spool 12 when the spool rotates to wind on the line 14 or wind off the line 14. The casing 16 supports a magnetic reed switch 32 (or Hall effect device, coil or the like) which is aligned with the magnet 30 so that every time the spool 12 rotates, the magnet 30 passes the reed switch 32. The reed switch 32 is connected to a processor and display 40 by hard wire connections 42. The processor and display 40 also is coupled to a reset button 44. The processor and display 40 also have a mode button 46.

Disposed between the handle 18 and the transmission 20 is a drag setting 50 which includes a tensioning wheel 52 for setting a particular pressure on the drag setting. Such drag settings are known and therefore will not be disclosed in detail hereinafter. The drag setting 50 includes a pressure sensing device 58 which is coupled to the processor and display 40. The sensing device 58 could be a pressure switch or an electronic unit such as a trim pot or variable resistor.

Thus, when the line 14 is cast or is retrieved by winding the handle 18, every revolution of the spool 12 will cause the magnet 30 to pass the switch 32 so that a pulse is produced which is transmitted to the processor and display 40 on hard wire connection 42. Thus, the pulses will provide a signal indicative of the speed of movement of the line 14 and the processor and display 40 can convert that signal into output signals representing various parameters related to the speed of movement of the line such as a distance travelled by the line or a rate of retrieve of the line or the depth the line is dropped in water. The particular parameter or mode which is displayed is set by merely pressing the mode button 46 so that the processor and display 40 calculates the particular parameter which is desired by the setting of the mode button and causes that parameter to be displayed based on the signal produced from the stationary magnetic reed switch 32.

Furtherstill, the pressure sensing device 58 also outputs a signal on hard wire connection 60 to the processor and display 40 so that upon depression of the mode button to bring up a pressure setting mode, the pressure set by the drag setting 50 can be displayed so that a user knows that a correct drag setting has been set by rotation of the wheel 52.

In the embodiment of FIG. 1, the processor and display 40 are mounted on or in the reel as is shown and are coupled to the switch 32 by hard wiring.

In the embodiment of FIG. 2, which only shows a fishing rod 70, a processor and display 40′ are located on the rod 70. Clearly, the magnet 30 and reed switch 32 would remain on the reel as shown in FIG. 1 as would the pressure sensing device 58 and a wireless transmission mechanism would be coupled to the switch 32 and pressure sensing device 58 with the wireless transmission mechanism being supported in or on the reel 10 so that a signal can be transmitted over the air for receipt by the processor and display 40′ so that the relevant data is transmitted over the air to the processor and display 40′ for display. Once again, a mode button 46′ is associated with the processor and display 40′ to select a particular parameter which is to be displayed.

FIG. 3 shows a still further embodiment in which the processor and display device 40″ and mode button 46″ are mounted on or in a reel 10″. The reel 10″ has a spool 12′ and has a rotating bail arm 72. The rotating bail arm 72 carries a magnet 74 and a magnetic reed switch 76 is fixed stationary to the reel in registry with the magnet 74 so that upon each rotation of the bail arm 72, the switch 76 would produce an output which is supplied to the processor and display 40″ for displaying a parameter as in the previous embodiments.

This embodiment could also include a pressure sensing device 78 for measuring the pressure set by a drag setting 80 and for displaying that pressure on the processor and display 40″ to ensure that the correct pressure has been set by the drag setting.

FIG. 4 shows a block circuit diagram of the display and processor 40 according to one embodiment of the invention.

With reference to FIG. 4, reed switch 32 is connected to a battery 101 so that every time the reed switch closes, a pulse is supplied to a pair of one shot multivibrators 103 and 104 which produce output pulses, the pulse width of which are set by suitable resistances and capacitance (not shown) coupled to the multivibrators 103 and 104. The pulse produced when the switch 32 is closed is also directly coupled by a line 105 to AND gate 107. The AND gate 107 is also connected to the output of the second vibrator 104 by line 108. When signals are received on lines 105 and 108, the AND gate 107 produces an output to a microprocessor 109 on line 110. The microprocessor therefore receives input pulses corresponding to the closures of the switch 32 which in turn correspond to each revolution of the spool 12 or bail arm 72 or other moving part. The microprocessor 109 is therefore able to calculate various parameters such as a distant measurement from the pulses received on line 110 or a rate of speed of retrieval of a line for transmitting to a display screen 111 so that the appropriate parameter can be displayed together with an indication of what the parameters are such as, a retrieve meters per second measurement or a distance measurement et cetera.

Furthermore, the pressure switch 50 is also coupled to the microprocessor 109 so that a pressure can be calculated by the microprocessor 109 and displayed on the display screen 111. Once again, the mode button 46 can be used to switch between various display modes and the reset button 44 can enable the device to be reset when a different mode parameter of a display is required.

In FIG. 5, a wireless transmission system is used in which the battery 101 also supplies signals to the multivibrators 103, 104 which in turn provides an output pulse to an amplifying and oscillating circuit 120 which includes a coil for wireless transmission of a signal 121. The signal 121 is received by receiver 123 which provides a signal to microprocessor 109 for display of information on display screen 111 in the same manner as previously described.

In this embodiment, the processor and display 40 comprise only the microprocessor 109 and display screen 111 which are coupled with a receiver 123 so that the display 40 can be located remote from the sensor such as on the fishing rod or elsewhere.

The multivibrators 103 and 104 and oscillating circuit 120 which forms a transmitter can be included as part of the reed switch mechanism 32 and included on or in the reel 10.

FIG. 6 shows a rod 250 according to a further embodiment of the invention. In this embodiment, the rod has a handle portion 200 which has a grip section 202. The handle portion 200 has a cutout 204 for receiving the reel shown in FIG. 7 which will be described in more detail hereinafter. The cutout 204 may include a catch element 206 and recess 208 for securing the reel of FIG. 7 in the recess 204 and therefore to the handle portion 200.

The recess 204 includes contact elements 210 and wires 212 extend from the contacts 210 to a liquid crystal display 214 which could be mounted in or on the rod as shown or at any other convenient location.

In FIG. 7, a reel 220 is shown which may be similar to the reels described with reference to the previous embodiments and which includes a pressure sensor 224 and a reed switch 226 and associated magnet 228 which is provided on a bail arm 230 or other moving member of the reel 220.

The reel 220 has contacts 240 on an outer surface thereof and the contacts 240 are connected to the pressure sensor 224 by wires 244 and to the reed switch 226 by wires 246.

When the reel 220 is coupled to the rod shown in FIG. 6 in the recess 204, the contacts 240 (FIG. 7) come into contact with the contacts 210 (FIG. 6) so that an electrical connection is made between those contacts to thereby hard wire the switches 224 and 226 to the display 214. The display 214 may also include a processor for processing signals received on the wires 212 or the processor may be included in the reel 220 and signals suitable for creating a display on the display 214 transmitted via the contacts 240, the contacts 210 and the wires 212 to the display 214.

The rod 250 has the mode button 46′ on grip 202 for easy activation by a user's finger.

FIGS. 8 to 10 show a further embodiment of the invention which does not rely on monitoring the rotation of the spool of a fishing reel or a bail arm of a fishing reel in order to obtain an indication of the amount of line wound onto or off the fishing reel. If the reel or bail arm is monitored, it is assumed that for each rotation a fixed length of line is wound onto or off the reel. However, in actuality, as the diameter of the spool of line on the reel changes as the line is wound onto or off the reel, the length of line wound onto or off the reel with each rotation of the spool or bail arm alters slightly. Thus, errors in the amount of line wound onto or off the reel will occur in the earlier aspects of the invention. FIGS. 8 to 18 show further embodiments which are not subject to this discrepancy in accuracy as the spool diameter of the line on the reel changes.

With reference to FIGS. 8 and 9, an indicator device 300 is shown which includes a pad 302 of rubber, foam or other resilient or soft material. A base plate 304 is fixed to the pad 302 and the base plate 304 mounts a rotatable measurement wheel 306 and an idler wheel 308. The rotatable wheel 306 carries a magnet 310 and a reed switch 312 is fixed to the base plate 304 so that the wheel 306 and therefore the magnet 310 can rotate relative to and past the reed switch 312.

As is best shown in FIG. 9, the device 300 can be fixed to a fishing rod 320 by suitable fasteners 322 which may be straps, clips or the like.

As is best shown in FIG. 10, the wheels 306 and 308 are provided with a groove 324a about their circumference for accommodating a fishing line 324.

As is best shown in FIG. 8, the fishing line 324 is wound about the idler wheel 308 and also about the measurement wheel 306 so that the line 324 engages both the wheels 308 and 306. The winding of the line about the wheels 306 and 308 as shown in FIG. 8 will cause the line to engage the wheels particularly when some tension is applied to the lines by a sinker or other weight at the end of the line.

The reed switch 312 is connected to a processor (not shown) which is identical to the processor previously described in the earlier embodiments either by hard wiring or by a transmitter and receiver system for wireless transmission of data signals as also previously described. As the line 324 moves during a cast, or when the line is dropped so as to sink vertically in water, or when the line is retrieved, the tension of the line 324 and the engagement with the wheel 306 will cause the wheel 306 to rotate. For example, if the line is being retrieved by being drawn in the direction of arrow A in FIG. 8 onto a reel (not shown) the wheel 306 will rotate in the direction of arrow B (and wheel 308 in the direction of arrow C). Rotation of the wheel 306 in the direction of arrow B will cause the magnet 310 to pass the reed switch 312 so that the reed switch 312 will sense the presence of the magnet and provide an output signal to the processor (not shown) as described in the earlier embodiments. The distance of movement of the line 324 and the amount of rotation of the wheel 306 is directly proportional at a 1:1 ratio so that for every rotation of the wheel 306, the line 324 has moved a distance equal to the circumference of the wheel 306 as engaged by the line 324. Therefore, each output pulse provided by the reed switch 312 is equivalent to a distance equal to the circumference of the wheel 306 regardless of the diameter of the spool of line 324 which remains on the reel (not shown).

The processor (not shown) which receives the pulses from the reed switch 312 can therefore calculate a distance measurement or a rate of retrieval measurement which is very accurate and does not suffer from inaccuracies due to the change in diameter of the spool of line on the reel as may be the case in the earlier embodiments.

In this embodiment of the invention, the device 300 could be formed on the rod so as to be a fixture on the rod or could be formed as a separate part for location on the rod. Alternatively, the fixture may be provided on a section of a rod which can be purchased and added into or onto an existing rod.

The device can be located in close proximity to a guide ring on the rod or may replace a guide ring on the rod and act as a guide for guiding the line in place of one of the guide rings usually located on the rod.

The processor (not shown) may be included within the section of the rod, embedded in the rod or located as described with reference to any one of the earlier embodiments. The display may also be located as described with reference to any one of the earlier embodiments. As in the earlier embodiments, the data from the sensor 312 to the processor and from the processor to the display may be by wireless transmission or by hard wiring.

FIG. 11 shows a different embodiment of the invention in which like reference numerals indicate like parts to those previously described.

In this embodiment, the two wheels 306 and 308 are provided so that the line 324 passes directly between them and so the line 324 is effectively sandwiched and therefore forced into engagement with the wheel 306. As the line moves, the wheel 306 will be rotated as in the earlier embodiment so that as the magnet 310 passes the reed switch 312, output pulses will be produced for supply to the microprocessor.

FIG. 12 shows the device of FIG. 11 mounted on a portion of a reel instead of being mounted on the rod as is the case in FIG. 9.

The device 300 could be located on other parts of the reel 330 such as the rear of the reel with the line being fed through the device 300 in the same manner as describe with reference to FIG. 11 or FIGS. 13 to 18.

FIG. 13 shows a further embodiment wherein the rod 320 is provided with upper and lower integral flanges 350 (only the upper flange being shown in FIG. 13). A single wheel 352 is mounted for rotation between the flanges 350 and the wheel 352 carries a magnet 354. A reed switch 356 is located on the rod 320 inwardly of the wheel 352 and the line 324 is guided about the wheel 352 so that the wheel 352 is rotated as the line 324 moves.

FIG. 14 shows an embodiment similar to FIG. 13 except two upper and lower flange portions 350a and 350b are provided. The flange portions 350b mount the wheel 352 which carries the magnet 354 and the flange portions 350a mount an idler wheel 360. The line 324 is wound about the wheels 352 and 360 generally in the same manner as described with reference to FIG. 8. Once again, a reed switch 356 is arranged on the rod 320 inwardly of the wheel 352.

FIG. 15 shows an arrangement where two idler wheels 360 are provided with the wheel 352 arranged between two idler wheels. In this embodiment, a single slightly enlarged pair of flanges 350 is provided for mounting the wheels 352 and 360.

FIG. 16 shows an embodiment where a pair of wheels 352 and 358 are arranged in a similar configuration to that described with reference to FIG. 11. The wheels are mounted between upper and lower flanges 350 (only the upper flange being shown). In this embodiment, a biasing mechanism such as a spring assembly 368 is provided for biasing the wheels 352 and 358 towards one another so as to tightly squeeze the line 324 therebetween to ensure engagement of the line 324 with the wheel 352 so that the wheel 352 is rotated as the line 324 moves.

FIG. 17 shows an embodiment using a single wheel 352 with the line 324 being wound completely about the periphery of the wheel 352 for a full 360°.

FIG. 18 shows a further embodiment which, unlike the embodiments previously described which disclose an electronic system in which electric signals are produced by the magnet 354 and reed switch 356 which are in turn applied to a microprocessor and then to a liquid crystal or other electronic display, utilises a mechanical display 400. The mechanical display 400 includes cylinders or drums 401 on which numerals are arranged and which are rotated by a mechanical gear system or the like so as to display a distance measurement.

In this embodiment of the invention, the line 324 is wound about wheel 370 in the same manner as previously described, for example, with reference to FIG. 13. However, wheel arrangements as described with reference to the other embodiments could also be utilised if desired. Instead of the wheel 370 being provided with a magnet, the wheel 370 is provided with teeth 372. The teeth 372 mesh with a gear wheel 374 which has teeth schematically shown by reference numeral 378. The gear wheel 374 may be an existing gear within the display 400 or may be a separate gear interposed between the gear 370 and the mechanical display 400. As the wheel 370 is rotated, the teeth 372 mesh with the teeth 378 to drive the gear 374 to in turn drive the mechanical display 400 so as to display a distance measurement or possibly a speed measurement.

The device 300 may be mounted so that it is on top of the rod 320 as shown in FIG. 9 when the rod is in normal use or beneath the rod dependent upon the location of the reel. However, obviously it is desired that the display always be arranged on top of the rod so that it is easily visible when the rod is in normal use.

With reference to FIG. 19, a still further embodiment of the invention is shown. This embodiment of the invention comprises a housing 400 which supports a rotatable wheel 402. The housing 400 has a pair of housing halves 403 and 404 which are pivotally mounted to a backing plate 405 on pivot pins 406. The backing plate 405 is provided with a slot 407 and cutouts 409. The cutouts 409 enable slip connection with projections (not shown) on a coupling bracket 410 in a known manner to enable the backing plate 405 to be connected to the bracket 410. The bracket 410 connects to a fishing rod (not shown in FIG. 19) by passing an appropriate screw or bolt through aligned holes 411 in lugs 512 and 414 so as to cause the lugs 512 and 414 to clamp about a fishing rod.

As shown in FIG. 19, a display unit 412 is mounted on a base plate 413. The base plate 413 includes contacts 413a which electrically connect with contacts (not shown) on unit 412 when the unit 412 is slid into engagement with the base plate 413. The display 412 can then include the liquid crystal display for displaying the required parameter, together with the processing circuitry for processing the signal indicative of movement of the fishing line. The unit 412 may be formed in two halves which can be coupled together by screws, bolts or ultrasonic welding or the like.

The processor and display unit 412 is provided for displaying the parameters as previously described. The base plate 413 can couple onto one of the bolts (not shown) which passes through the holes 411 in lugs 512 or 414 so that the display unit 412 and base plate 413 can be pivoted relative to the rod from a generally flat retracted position to an upwardly inclined position to provide for better viewing. The bolt (not shown) which passes through one of the aligned pairs of holes 411 of lugs 512 or 414 passes through boss 415 which is provided with a central hole 416 so that the bolt will pass through the aligned holes 411 in the lugs 512 or 414 and the hole 416 to thereby couple the display 412 and base 413 to the rod for pivotal movement from the retracted position to the upwardly inclined position.

As shown in FIG. 19, the display 412 may include a mode button 417 and reset button 419. The reset button 419 merely resets the display to a zero value for a new reading and the mode button 417 enables a particular parameter such as line retrieval speed, line distance, depth of water or the like to be displayed by simply pressing the mode button 417 so that, in turn, each parameter will be displayed in turn. Thus, the mode button merely causes the processor to process the input signal in a manner to provide the particular parameter which is required and then causes that parameter to be displayed on the liquid crystal display within the display 412. One of the parameters which is displayed may be a bite indicator in which, if the mode button is pressed to place the processor and display into that mode will cause an alarm (not shown) to sound or a light (not shown) to flash as soon as the line moves to in turn rotate the wheel to cause an output from the unit 430. Any movement of the line in this mode being taken as indicating a bite. Thus, after the line is cast and when the rod is merely being held awaiting a bite, the mode button can be depressed to place the processor and display 412 into the bite indicator mode so that the alarm or light will flash as soon as the line is pulled.

As is clearly shown in FIG. 19, the housing halves 403 and 404 of the housing 400 are provided with slots 418 so that the fishing line 420 can pass through one of the slots 418 wrapped completely around the wheel 402 and exit the other slot 418 (not shown in FIG. 19).

As is best shown in FIG. 20, the backing plate 405 is provided with a shaft 420 which has a groove 421 adjacent its outermost end. Wheel 402 is provided with a central opening 402a and is also provided with a magnet 507. A bearing 422 is force fitted into the opening 402a and the bearing 422 is located on the shaft 420. A circlip 423 locates in the groove 421 to secure the bearing 422 and therefore the wheel 402 onto the shaft 420.

The housing halves 402 and 403 define a central opening 425 which receives the wheel 402 and in which the wheel 402 can freely rotate as is more clearly shown in FIG. 19. The housing halves 402 and 403 are secured to the backing plate 405 by the pivot pins 406 which have screw threaded ends 406a which screw into screw threaded holes 427 in the backing plate 405. Spacer washers 428 may be provided to space the housing halves 402 and 403 from the backing plate if desired. The two housing halves 402 and 403 have a snap clasp 419a arranged between their upper portions so that the two halves 402 and 403 can pivot into an open position in the direction of arrows J in FIG. 20 so that the fishing line 420 (shown in FIG. 19) can be located through one of the slots 418 wrapped completely around the circumference of the wheel 402 in groove 402b of the wheel and out through the other slot 418. The two housing halves 402 and 403 can then be closed by pivoting them in the direction opposite arrows J so that they turn to the position shown in FIGS. 19 and 20 and lock together by means of the clasp 419a. The clasp 419a may merely be a snap lock arrangement or alternatively could comprise magnets for retaining the two halves 402 and 403 in the closed position.

The slot 407 of the backing plate 405 receives sensor unit 430 which is configured in a shape corresponding to the slot 407. The sensor element 430 includes a reed switch, an appropriate output line (not shown) and, as will be apparent from FIGS. 19 and 20, when the unit 430 is located in the slot 407, the reed switch will be positioned in proximity to the magnet 507 so that each time the magnet 507 passes the unit 430, the reed switch can produce an output signal which can be passed via output wire (not shown) to the display 412 shown in FIG. 19.

FIG. 21 shows another embodiment of the invention in which a pair of housing halves 432 and 433 are coupleable together to support wheel 442 which is similar to the wheel 402 previously described except that it has a permanent axle 443 connected thereto. The wheel 442 seats in a circular cutout 444 in housing part 433 and the axle 443 is supported in a first bearing 435 which locates in hole 446 of housing 433 and a second bearing 437 which locates in hole 438 in housing 432. Thus, the wheel 442 is supported by its axle 443 in the bearings 437 and 435.

A bolt 439 may pass through the bearing 437 and screw into a screw thread in the axle 433. The housing half 433 is maintained in place adjacent housing half 432 by a fixing bracket which is the same as the bracket 410 shown in FIG. 19.

The housing half 432 is provided with a cutout slot 450 which is substantially identical to the slot 407 in FIGS. 19 and 20 for receiving the unit 430 which is the same as unit 430 previously described. The unit 430 is connected by a wire 439 (shown in FIG. 21) to the base plate 413 which is in contact with display 412 via contacts 413a previously described.

The upper portion 451 of the housing halves 432 and 433 may be provided with slots or cutouts 452 to enable the housing halves 432 and 433 to couple with a coupling bracket which is the same as the coupling bracket 410 described in FIG. 19.

In the embodiments of FIGS. 19, 20 and 21, the housings described effectively form guide elements for guiding the fishing line 420 relative to a fishing rod (not shown). The housings may replace a conventional guide ring coupled to the fishing rod or may be in addition to the usual guide rings which are connected to the fishing rod.

FIG. 22 shows yet a further embodiment of the invention in which a housing 460 is configured for coupling with a rod 462 in a similar manner to the manner in which conventional guide rings are coupled to the rod 462. The housing 460 has a pair of legs 463 which are provided with foot members 464. The foot members 464 can be bound to the rod 462 by a cord (not shown) in a similar manner to the manner in which guide rings are bound to a fishing rod.

The housing 460 has a pair of housing plates 465 and 466 which define between them a space 467. The plate 465 is provided with a U-shaped cutout 468 for receiving sensor unit 430 which is the same as the sensor unit 430 previously described. FIG. 22 shows the sensor unit 430 connected by its wire 439 to base plate 413 and display 412 (FIG. 19).

The plates 465 and 466 include aligned openings 470 (only one shown) for receiving wheel 402 or 442 as described in FIGS. 19 to 21. The bearings for supporting the wheel 402, 442 are omitted from FIG. 22 for ease of illustration.

The plates 465 and 466 also have a pair of aligned openings 471 and 472 and idler rollers 473 and 474 are arranged between the aligned openings 471 and 472 respectively. A cover plate 480 of generally inverted U-shaped configuration is provided with a pair of arms 481 which have slots 482. The cover plate 480 also has front and rear walls 483 and 484 and aligned openings 485 are provided in the walls 483 and 484. After the rollers 473 and 474 are located between the plates 465 and 466, bolts can pass through the aligned openings 485 and 483 and the corresponding holes 471, 472 and rollers 473 and 474 to thereby secure the cover plate 480 to the housing 460 and also secure the rollers 473 and 474 in place.

A fishing line (not shown) can pass through the slot 482, underneath roller 473, over wheel 402, 442, underneath wheel 474 and out through the opposed slot 482.

Thus, the fishing line is guided to wrap partly around the wheel 402, 442 so that when the fishing line moves, the wheel 402, 442 is rotated to cause magnet 507 to pass unit 430 to provide an output signal to the base plate 413 and display 412 as previously disclosed.

FIG. 23 is an illustration of an embodiment in which wireless transmission is used from the unit 430 to the display unit 412. The unit 430 may be included with a transmitter unit and the display 412 may include a receiver unit so that over the air transmission of radio waves from the unit 430 will be detected by the receiver in the unit 412 so that the output signals produced by the magnet 407 passing the unit 430 are supplied to the unit 412 for processing by the processor in the unit 412 and for display of the required parameter.

FIG. 24 shows in more detail the processing circuitry of the earlier embodiments and, in particular, the processing circuitry within the housing 412 of the embodiments of FIGS. 19 to 23.

FIG. 24 shows the wheel 402 of the earlier embodiments, including the magnet 507 in engagement with line 420. As the wheel 402 is rotated, the wheel passes sensor 430 as previously described. The sensor 430 includes two reed switches 651 and 652. The two reed switches enable the direction of rotation of the wheel 402 to be determined dependent upon which of the reed switches is activated first. If the wheel 402 is rotating clockwise, the reed switch 651 will activate first then followed by the reed switch 652. If the wheel 402 is rotating in the opposite direction, the reed switch 652 will activate first then closely followed by the reed switch 651. Thus, a determination can be made as to whether the line 420 is moving out or being wound in.

The sensor unit 430 has three outputs which are connected to inputs 621, 622 and 623 of a processor 600. The input 621 is coupled to the reed switch 651 and the input 623 is coupled to the reed switch 652. The input 622 is a common from both reed switches as shown. Thus, when the reed switch 651 closes, a pulse is received on input 621 and when reed switch 652 closes, a pulse is received on input 623. If the pulse is received at input 621 within a predetermined time interval prior to the receipt of a pulse on input 623, the processor knows that the wheel 402 is rotating in a clockwise direction. If the opposite occurs, the processor 600 knows that the wheel 402 is rotating in an anti-clockwise direction. The predetermined time interval is such that within normal use of the device, the time is shorter than the time it would take for the magnet 507 to move the large distance from, for example, the reed switch 651 in an anti-clockwise direction to the reed switch 652 so that the sequence of closing of the switches 651 and 652 is indicative of the direction of movement of the wheel 402.

In the embodiment shown, the coupling of the unit 430 to the inputs 621 to 623 is by hard wire. However, in other embodiments as previously described, the coupling could be by wireless transmission.

The mode button 417 is connected to input 601, a light switch 631 is connected to an input 602 and the reset button 419 is connected to input 603. If the light switch 631 is depressed, the input received by the processor 600 causes a light 633 which is connected to output 605 of the processor 600 to be illuminated. An alarm 632 is coupled to output 604 of the processor 600 and could be used to indicate an alarm function showing that undesired speed of line retrieval is taking place or that a bite has occurred or some other function of the processor. Similarly, the light 633 could be automatically illuminated to indicate the function previously described instead of the audible alarm 632.

Input 606 is a common for the switches 417, 631, 419 and the alarm 632 and light 633.

The processor 600 is connected to display 630 via bus 657 so that data from the processor can be displayed on a liquid crystal display 630.

An oscillator circuit 610 is coupled to input 607, 609 and 614. The oscillator 610 includes capacitors 611, 612 and a crystal oscillator 613 for providing time impulses to the processor 600.

A battery 617 is connected to power supply terminals 615 and 616.

An all clear button 634 is connected between input 619 and common 618.

As previously described, the mode button 417 selects the appropriate mode for the processor to display required information as will be described in more detail with reference to FIGS. 25 to 28. The reset button resets the display 630 to zero when needed (for example if a line breaks and the user is left with residual reading on the display 630).

The all clear button 634 is preferably provided on the underside of the housing 412 which can be accessible via the base plate 413 (FIG. 19) and can be used to change data in the processor 600.

An input 608 is provided for providing input signals from an ancillary device (not shown) such as weight scales or the like.

FIGS. 25 to 28 show a flow chart illustrating operation of the processor 600.

At step 701, power is supplied to the processor 600. At step 702, a RAM in the processor 600 is cleared. At step 703 all the LCD segments of the display 630 are turned on and at step 704 a delay of 2 seconds takes place while all segments of the display 630 are turned on and at step 705, all of the segments of the display 630 are turned off. This merely indicates that all segments of the display 630 are functioning correctly. At step 706, the wheel size of the wheel 402 is displayed and at step 707 a delay of 2 seconds occurs while the wheel size is displayed. At step 708, all segments of the display 630 are turned off. The display at step 706 merely enables the user to ensure that the wheel size data programmed into the processor 600 is correct for the wheel 402 which is actually being used. Thus, if a user needs to replace a wheel 402, the user can ensure that the correct sized wheel 402 is obtained, or if the processing circuitry is being obtained separate from the wheel 402, the processing circuitry can be adjusted if necessary to ensure that the processor 600 is programmed with the correct wheel diameter so that a correct distance measurement is obtained for each pulse received by the processor 600 which is indicative of the wheel diameter of the wheel 402.

At step 709, the display 630 shows data to be set ie km/hr, miles/hr etc. At step 710, the processor checks for operation of the mode button 417 or reset button 419. If the mode button 417 is depressed at this time, the processor can change at step 711 to display data in miles per hour. If this occurs, the processor will go back to step 709 and then to step 710. By continued pushing of the mode button 417, the processor can switch between displaying data in kilometres per hour or miles per hour until the appropriate units are being displayed for the user's requirement. The user can then depress the reset button 419 and the program will move to step 712 where the data required for calculations is dependent on whether the kilometre per hour or miles per hour function set at steps 709 or 711 has been selected so that the appropriate data for calculating in kilometres per hour or miles per hour is set in the processor 600 for the calculation purposes.

The process then moves to step 713 which displays distance/depth and metres symbol. The process then moves to step 714 for depression of the mode button 417 or reset button 419. If the mode button 417 is pressed, the process moves to step 715 which will change the distance depth measurement from metres to yards or feet by continued pressing of the mode button 417. When the correct unit is being displayed for the user's purpose, the user can depress the reset button 419 and the program will move to step 716 which will cause the required data to be supplied to the random access memory of the processor 600 for calculations in metres, yards or feet, dependent upon which has been selected at steps 713 and 715.

At step 717, timers and counters are initialised and the display 430 is set to zero. The processor 600 is now awaiting data from the sensor unit 430. At step 718, the processor is awaiting inputs from the unit 430 at inputs 621 and 623. If no inputs are obtained, the program will simply remain at this step until inputs are received. When the inputs are received, the program moves to step 719 which determines whether the reed switch 651 or reed switch 652 is closed first so that the processor knows which way the wheel 402 is spinning and therefore knows whether the line 420 is being cast out or drawn in. The program preferably automatically goes into a mode whereby a distance measurement will be obtained by steps 720 to 730 as will be described in more detail hereinafter when the line is cast out and will then switch to a retrieval mode after the line has been cast out, unless the mode button 417 is depressed to place the processor 600 in a mode only which will give a distance measurement for line out during casting or line in during rewinding of the line. Thus, assuming that the line is cast out, the wheel 402 will rotate in an appropriate direction indicating that the line is being cast out and the process will move to step 720 where a revolutions counter in the processor 600 is incremented for each pulse which is received at the input 621 (for example). The process then moves to step 721 which is a distance processing subroutine which is described in more detail in FIG. 27.

At step 722 of FIG. 27, the data in the rev counter at step 720 is obtained and in step 723, that data is converted to a binary coded decimal number. At step 724, the processor checks which desired data has been selected at step 713 or 715 for display in metres, yards or feet etc and dependent upon which unit was selected, the process then moves to step 725 or step 726 or step 727 where the pulse count number which is indicative of the wheel diameter 402 is multiplied by the appropriate factor for displaying in yards, feet or metres. At step 728, the distance measurement which is obtained by multiplying the pulse count by the appropriate factor is stored. The process then moves to step 730 in FIG. 26 where the distance value stored at step 728 is displayed on display 630.

The process then returns to step 718 for processing of the next pulse. Thus, as the line is cast out and the distance increases and the number of pulses increases, the display of the step 730 will be updated with the increasing distance as the line moves. When the line stops, a final display will be indicated thereby providing an indication of the distance of the cast or, alternatively, if the line is merely dropped over the edge of a bank, the depth at which the line has been dropped in the water.

Normally, the fisherman will then leave the line resting for a short time and, assuming that the fisherman is using a lure and wishes to draw in the lure so the lure moves through the water mimicking the natural action of a food source, the wheel 402 will begin to rotate in the opposite direction to that which occurred when the line was cast out. The reed switches 651 an 652 will then close in the opposite sequence and at step 718, the pulses will be detected. At step 719, the program will realise that the pulses are being received from the reed switches 651 and 652 in the opposite sequence and will therefore move to step 731 which will initialise the retrieval speed counter in the processor 600. At step 732, the retrieval timer will start and at step 733, the processor 600 will check to determine whether the mode button has placed the device in only distance mode or in the retrieval mode. If the mode button 417 has placed the processor 600 only in distance mode, the process moves to step 734 where the r v counter at step 720 is decremented. The process then moves to subroutine 721 for the calculation of distance measurements so that the decreasing distance from that which was originally cast is displayed on the display 630 as the line is wound in.

If the mode button 417 places the device in the retrieval mode, the processor moves from step 733 to step 735 where the retrieval speed counter is incremented. At step 736, the rev counter 720 is decremented indicative of the draw of the line as per step 734. At step 737, the program determines whether the retrieval timer set at step 732 has expired. If not, the process returns to step 733 and continues through step 734 or step 735, 736 until the timer has expired. When the timer has expired, the processor moves to a velocity subroutine at step 740 which is shown in more detail in FIG. 28.

With reference to FIG. 28, at step 741, the count from the retrieval speed counter which was started at step 731 is obtained and the data is converted to a binary coded decimal number at step 742.

At step 743, the processor 600 checks as to whether data is to be displayed in kilometres per hour or miles per hour or the like and, depending upon which unit was selected at step 709 and 711, the process then moves to step 744 or step 745 to multiply the data received at step 742 by the appropriate factor for display in miles per hour or kilometres per hour. The process then moves to step 746 where the multiplied data is stored.

The program then returns to FIG. 26 where the process at step 750 causes the speed data to b displayed on the display 630. Thus, the display shows the retrieval speed of the line in miles per hour or kilometres per hour or whatever other unit is programmed into the processor and selected by the user.

At step 751, the program checks as to whether inputs are still being received from the sensor unit 430 and, if so, the program returns to step 719 for continued operation. If no inputs are obtained, the process moves to step 721 so that distance data can be displayed as per subroutine 721. Thus, when the user is retrieving the line and dragging in the lure or bait etc, the retrieval speed will be continuously displayed so the user can determine that the line is being drawn in at the desired speed and, if not, the user can adjust the winding speed of the reel attached to the fishing rod to ensure that the desired retrieval speed is obtained. Once the user stops drawing in the line, the program will revert to subroutine 721 where the distance will be displayed indicating the distance of line which is still out compared to that which was originally cast.

If the user decides to simply recast the line and again retrieve the line, this will be determined at step 718 and 719 and the program will revert to the appropriate step 720 or step 731 depending on whether the line is being cast out or retrieved.

Apart from the functions previously described, the microprocessor and display 40, 412 may also include the following features:

an inbuilt light or glowing screen so that the display screen can be viewed at night;

maximum speed memory mode, average speed memory mode, maximum distance/depth memory mode;

spool loading mode to tell a user how much line has been loaded onto a reel;

a time and date and alarm function (i.e. conventional clock function for display of time on the display screen;

stop watch timer function;

a temperature measurement function;

a tide chart function;

a barometric pressure function;

a compass function;

a global positioning system;

a memory log system (i.e. position or type of fish caught);

a moon phase chart;

an input terminal for connecting a weight device or temperature probe; and

a strike alarm function mode.

Thus, the microprocessor and display 40, 412 may act as a conventional watch or other display device for displaying a variety of conventional pieces of data which may be of assistance to a fisherman.

Since modifications within the spirit and scope of the invention may readily be effected by persons skilled within the art, it is to be understood that this invention is not limited to the particular embodiments described by way of example hereinabove.

1. A fishing indicator device comprising:
a sensor for sensing retrieval speed of a fishing line onto a fishing reel for producing a signal indicative of the speed of retrieval of the fishing line;
processing means for receiving said signal and for producing an output signal indicative of retrieval speed of the fishing line; and
display means for receiving said output signal and for displaying said retrieval speed.

2. A fishing rod having a fishing indicator device according to claim 1.
